(19) United States
(12) Patent Application Publication
(10) Pub. No.: US 2021/0274815 A1
(43) Pub. Date: Sep. 9, 2021

(54) Nutritional Formulations For Fat Burning and Hydration

(71) Applicant: James M. Manoyan, New Haven, CT (US)

(72) Inventor: James M. Manoyan, New Haven, CT (US)

(21) Appl. No.: 17/191,155

(22) Filed: Mar. 3, 2021

Related U.S. Application Data
(60) Provisional application No. 62/984,370, filed on Mar. 3, 2020.

(51) Int. Cl. A23L 2/60; A23L 33/175; A23L 29/00; A23F 3/16; A23L 33/00; A23L 29/30; A23L 33/105; A23L 2/02; A23L 33/15

(52) U.S. Cl. CPC A23L 2/60; A23L 33/175; A23L 29/035; A23F 3/16; A23L 33/15; A23L 29/35; A23L 33/105; A23L 2/02; A23L 33/40

(57) ABSTRACT

Liquid beverage compositions having L-glutamine in an amount of about 0.01 to about 1.0 percent by weight of the composition. The compositions may also include L-citrulline, or tea concentrate. The beverages are ingested to promote body toning, induce metabolization, and increase blood levels of growth hormone.

### FIELD OF THE INVENTION

The invention relates to oral nutritional supplements and their methods of manufacture. In particular, the invention relates to beverages including glutamine that aid in fat burning and hydration, as well as vasodilation, muscle recovery and growth, and decreasing inflammation.

### BACKGROUND OF THE INVENTION

The use of health or sport drinks to satisfy various requirements of the human body during training and competition is known. Many of the health drinks on today's market, designed to provide energy and to replete the body of lost salt and water after heavy exercise or competition, are based on the assumption that the rates of water and salt loss during these times exceed the body's normal intake and the kidney's ability to process the blood. By repleting or refurbishing the salt and water which are lost, the purpose of the majority of health drinks is to attempt to maintain a state of constancy in the blood. Accordingly, many sport drinks contain water and/or electrolytes. Usually, some sugar is added to restore glycogen stores and to make the drink more palatable to the consumer.

Various health or sport drinks may also contain some vitamins and minerals directed to meet particular nutritional needs of the athlete or consumer involved. Examples of such sport drinks include GATORADE® and PROPEL®, marketed by Stokely-Van Camp, Inc. GATORADE® contains a 6% solution of sucrose and glucose, 220 mg of sodium and 50 mg of potassium per serving as well as some vitamin C; PROPEL® contains a mix of Niacin (B3), B6, B5, and Vitamins C and E. POWERADE®, marketed by the Coca-Cola Company is comparable to GATORADE. Other hydration focused beverages include World Waters, LLC's WTRMLN WTR SportWTR™, which is rich in L-citrulline, electrolytes, lycopene, and Vitamin C; NOOMA® Organic Drinks, comprising water, a root extracts blend, juices and/or coconut water, flavor and stevia. LIQUID I.V. HYDRATION MULTIPLIER® is a commercial product that contains sugars, stevia, and Vitamins C, B3, B5, B6 and B12, among other ingredients that are added to water.

U.S. Pat. No. 4,871,550 discloses a nutrient composition which is said to enable stressed marathon athletes to achieve superior performance. The composition contains essential, and preferably also non-essential, amino acids, nutrient factors which may include vitamins, trace elements and minerals, and may also include carbohydrates, electrolytes and one or more flavoring aids.

A drink that is administered prior to exercising is disclosed by U.S. Pat. No. 4,687,782. This patent is directed to a diet supplement which employs a combination of amino acids mixed with water to form a drink that is said to be useful to promote muscle adaptation to strenuous exercise. It requires the combination of the amino acids carnitine, glutamine, isoleucine, leucine and valine and can be supplemented with other proteins, vitamins and/or minerals.

JP-59210872 discloses a drink for athletes that contains various amino acids including histidine, lysine, arginine, leucine, i-leucine and valine. The drink may also include an acidulent and carbonic acid.

WO 95/11019 discloses ingestible compositions for enhancement of physical performance and reduction of body fat that contain from about 1.0 to 4.0 g of glutamine per 473 milliliters. Glutamine was added to GATORADE and the effects on plasma glutamine, alanine concentration, growth hormone concentration, and plasma arginine concentration, and bicarbonate were studied.

Fat burning, hydration, vasodilation, muscle recovery and growth, and decreasing inflammation are desired features for a fitness drink, and for health in general. Consumers desire new products to meet these needs.

EP1738659 reports that sports beverages have what some consumers deem to be an excessive level of aftertaste. In addition, research has shown that athletes experience taste burnout due to the level of aftertaste typical of sports beverages. The publication discloses an allegedly improved sports beverage containing an acidulent system that results in a sports beverage with reduced total aftertaste and an increase in the pleasantness of the aftertaste as well as significantly higher gulpability compared to conventional sports beverages. However, such beverages do not contain glutamine.

There exists a need for improved sports and nutritional beverages that can aid in fat burning and muscle recovery, especially those containing glutamine. There exists a need for sports beverages that contain glutamine and have an optimal aftertaste and drinkability.

It is an object of the invention to provide beverages including glutamine that aid in fat burning and hydration, as well as vasodilation, muscle recovery and growth, and decreasing inflammation. It is an object of the invention to provide non-carbonated sports beverages that comprise glutamine that have optimal aftertaste and drinkability.

### SUMMARY OF THE INVENTION

The present invention relates to ingestible compositions designed to combine enhancement of physical performance with the reduction of body fat. More specifically, the present invention is directed to beverage compositions comprising glutamine and methods of consuming the beverages to promote body toning and/or for inducing metabolization and/or for increasing blood levels of growth hormone. Preferably, the beverage compositions are a non-carbonated sports beverage.

A first aspect is a liquid beverage composition comprising L-glutamine in an amount of about 0.01 to about 1.0 percent by weight of the composition, tea concentrate in an amount of about 15 to about 60 percent by weight of the composition, one or more anti-inflammatory agents in an amount of 0.00005 to 0.002 percent by weight of the composition.

The liquid beverage composition can further comprise L-citrulline.

In another aspect is provided a liquid beverage for increasing hydration comprising L-glutamine in an amount of about 0.01 to about 1.0 percent by weight of the composition; and L-citrulline in an amount of about 0.01 to about 1.0 percent by weight of the composition.

In yet another aspect is provided a liquid beverage composition comprising glutamine in an amount of about 0.01 to about 0.5 percent by weight of the composition, L-citrulline; and thickening agent.

The compositions can further comprise one or more amino acid selected from L-arginine, L-valine, and L-isoleucine and/or creatine.

In some embodiments, the liquid beverage compositions have a pH from about from about 2.7 to about 4.2

In certain embodiments, the compositions further comprise a low-calorie sweetener selected from the group consisting of mannitol, xylitol, hydrogenated starch hydrolysates, maltitol, isomalt, erythritol, lactitol and combinations thereof. In certain preferred embodiments, the low-calorie sweetener consists of erythritol.

In some embodiments, the compositions further comprise flavoring agent. In some of those embodiments, the flavoring agent is about 0.05 to about 2% by weight of the composition.

In some embodiments, the flavoring agent comprises at least one of a fruit flavor and a botanical flavor. In some of those embodiments, the botanical flavor comprises, consists essentially of, or consists of hibiscus.

In certain embodiments, the fruit flavor comprises monk fruit.

In some embodiments, the monk fruit is present in an amount from about 0.01 to about 1.0 percent by weight of the composition.

In certain embodiments, the fruit flavor comprises raspberry.

In some embodiments, the tea extract is obtained from Camellia tea materials.

In certain embodiments, the anti-inflammatory comprises resveratrol. In certain of those embodiments, the resveratrol is derived from grape skin extract.

In some embodiments, the compositions further comprise an acid selected from ascorbic acid, erythorbic acid, citric acid, and combinations thereof.

In certain embodiments, a thickening agent may be present in an amount of about 0.01 to about 0.3 percent by weight of the compositions.

In some embodiments, the thickening agent comprises, consists essentially of, or consists of agar.

In one embodiment, a nutritional beverage composition uses glutamine in conjunction with polyphenols and certain plant chemicals to put the body in a state of lipolysis; when this happens, the body consumes its adipose tissue (fat) and uses it as an energy source. The beverage includes resveratrol (from grape skin extract), in conjunction with a high concentration of the amino acid L-citrulline, which may be found in herbal and floral components of the beverage or as a separate ingredient, to have an effect of vasodilation; the aforementioned helps increase oxygen and nutrient delivery to muscle tissue. Once blood flow has increased, the glutamine is delivered into the muscles and helps the muscle recovery and growth process. The beverage also contains powerful anti-inflammatories that help reduce inflammation and accelerate the recovery process. Further, in combination with the increased blood flow, an anti-inflammatory can increase testosterone levels. The very same chemical structures that naturally occur in these plants, also helps improve digestive efficiency.

Methods of promoting body toning, inducing metabolization, and/or increasing blood levels of growth hormone comprise ingesting one or more of the aforementioned beverage compositions. In preferred embodiments, a human ingests about 12-36 ounces of a beverage composition per day.

### DETAILED DESCRIPTION OF THE INVENTION

In accordance with the present invention, it has been found that by adding a specified amount of the amino acids glutamine and citrulline to an ingestible composition, which is to be consumed prior to or after physical exertion such as exercise or an athletic performance, a growth hormone response is evoked in the consumer which results in the physical performance of the human body being enhanced as fat is burned and proteins are spared.

An exemplary glutamine beverage of the present invention promotes body toning, even in the absence of exercise, by facilitating the metabolization of fat in place of protein.

The beverages can be ingested as a method of inducing the metabolization of fat in a human and to induce an increase in the amount of growth hormone in blood.

As used herein, the term “ingestible composition” is generally defined as any composition which may be orally ingested by the consumer. Ingestible compositions in accordance with the present invention include beverage compositions, such as regular or diet beverages, regular or diet soft drinks, regular or diet sports drinks, powdered beverage formulations and the like, and foodstuff compositions, such as candy bars or power bars, cookies, wafers and the like, as well as a food ingredient which may be used or added to other foodstuffs. Preferably, the ingestible compositions are beverages, most preferably non-carbonated liquid beverages.

Beverages of the present invention comprise glutamine, citrulline and sweetener or fruit flavor, acids, colorants, and/or juice. In certain embodiments, the glutamine and citrulline are combined with tea extract. It has been found that the appearance of the tea extract containing beverages can be stabilized and enhanced if ascorbic acid, erythorbic acid or citric acid (lemon juice) are present in specified amounts either during the tea extraction process or in the beverage formula.

It is preferred that glutamine used in making the compositions is essentially pure, i.e., greater than 99% pure. Glutamine is purified in the crystalline form after extraction from its plant source and is available as such.

The glutamine is typically present in the beverage compositions from about 0.01% to 1.0% w/w, more preferably about 0.1% to 0.80% w/w.

In certain embodiments, the amount of glutamine is about 0.1%-0.35% w/w of the beverage composition, most preferably around 0.25% w/w.

In other embodiments, the amount of glutamine is about 0.50% w/w to about 0.75% w/w of the beverage composition.

In certain embodiments, the amount of glutamine can range from about 0.5 g to about 10.0 g of glutamine per 473 milliliters (16 fluid oz.). Preferably, glutamine should be added in an amount of 1 g to about 6 g per 473 ml, most preferably around 1 g to 2 g per 473 ml. Alternatively, the amount of glutamine can range from about 0.5 g to about 10.0 g of glutamine per 591 milliliters (20 fluid oz.). Preferably, glutamine should be added in an amount of 3 g to about 7 g per 591 ml, most preferably around 5 g per 591 ml.

It is preferred that citrulline used in making the compositions is essentially pure, i.e., greater than 99% pure. Citrulline is purified in the crystalline form after extraction from its plant source and is available as such. In certain embodiments, citrulline is provided in the composition by way of watermelon or hibiscus plant materials and extracts.

The citrulline is typically present in the beverage compositions from about 0.01% to 1.0% w/w, more preferably about 0.1% to 0.80% w/w glutamine, most preferably about 0.2% to about 0.4% w/w of the beverage composition.

In certain embodiments, the amount of citrulline can range from about 0.1 g to about 12.0 g of glutamine per 473 milliliters (16 fluid oz.). Preferably, citrulline should be added in an amount of 0.2 g to about 8 g per 473 ml, most preferably around 0.4 g to 5 g per 473 ml. Alternatively, the amount of citrulline can range from about 0.5 g to about 15.0 g of glutamine per 591 milliliters (20 fluid oz.). Preferably, glutamine should be added in an amount of 1 g to about 10 g per 591 ml, most preferably around 2 g-8 g per 591 ml.

When included in beverages in the aforementioned amounts, it has been found that glutamine and citrulline containing beverages enhance fat burning and hydration, as well as vasodilation, muscle recovery and growth, and decrease inflammation.

As used herein, the term “enhancing” or any form thereof, is defined as improving or elevating one's normal abilities under similar circumstances. Thus “enhancing” one's physical performance means not only increasing one's capacity to perform for a greater amount of time but performing at a greater capacity of power and strength due to the minimization of any wear-and-tear on the muscles involved in the performance. Further, the phrase “reducing fat” refers to the consumption, conversion or elimination of fat present in the body as by the process of actually burning or consuming fat via the ingestion of the growth hormone elevating compositions according to the present invention. That is, the term “reducing fat” as used herein refers to the process of inducing the metabolization of fat. This process can thus be accompanied by realization of weight loss. The term “reducing fat” can also include the situation where the consumer's metabolism is consuming fat due to the ingestion of the glutamine compositions in accordance with the present invention, but not actually “reducing” his or her overall fat level due to a simultaneous ingestion of more fat. In other words, depending on the eating habits of the consumer, a “reduction” in fat level is not always achieved. Thus, the compositions of the present invention can also be used for weight control or the maintenance of one's weight. Even in this aspect, the present invention is useful as desirable body toning occurs as the body's metabolism is shifted to fat, in preference to protein, as the energy fuel.

As used herein the term “fruit flavors” refers to those flavors derived from the edible reproductive part of the seed plant, especially one having a sweet pulp associated with the seed, for example, apples, oranges, lemon, limes, etc. Also included within the term fruit flavor are synthetically prepared flavors made to simulate fruit flavors derived from natural sources. These fruit flavors can be derived from natural sources such as fruit juices and flavor oils or synthetically prepared. If desired, fruit juices, including orange, pineapple, lemon, lime, apple and grape can be used as a flavor component. Preferred fruit flavors are grape, raspberry and lemon.

As used herein, the term “botanical flavor” or “botanical extract” refers to flavors derived from parts of the plant other than the fruit. As such, botanical flavors can include those flavors derived from nuts, bark, roots and leaves. Also included within this term are synthetically prepared flavors made to simulate botanical flavors derived from natural sources. Examples of botanical flavors include hibiscus, marigold, chrysanthemum and the like. These botanical flavors can be derived from natural sources such as essential oils and extracts or be synthetically prepared. Preferred botanical flavors are hibiscus and mint.

As used herein, the term “juice” means whole, concentrated or diluted juice from fruits and vegetables and other produce which are squeezed or crushed to supply a beverage. Juice also refers to citrus and non-citrus juices including some vegetable juices.

As used herein, the term “Vitamin C” refers to L-ascorbic acid. The term “erythorbic acid” refers to its isomer, D-isoascorbic acid.

As used herein, the term “tea materials” is meant to include freshly gathered tea leaves, fresh green tea leaves that are dried immediately after gather, fresh green tea leaves that have been heat treated before drying to inactivate any enzymes present, unfermented tea, instant green tea, partially fermented tea leaves are suitable for use. Tea leaves, tea plant stems and other plant material which are related and which have not undergone substantial fermentation to create black teas can also be used. I

In one embodiment, tea materials used in the beverages herein includes materials obtained from the genus Camellia including, e.g., Camellia sinensis and Camellia assaimica. Members of the genus Phylanthus, Catechu gambir or Unicaria family of tea plants can also be used.

As used herein “tea extract” refers to the product obtained by extraction of unfermented or partially fermented tea solids or tea material. This extraction can be carried out with water or solvents, and the resulting extract can be concentrated, for example, in liquid or paste form or dried, for example, in powder form. The term “tea extract” also refers to aqueous solutions produced from the liquid, paste or dried composition, prepared in such a way as to substantially reproduce the brew (tea).

The tea extracts of the present invention contain unoxidized flavanols. These flavanols exhibit a strong tendency to cloud and produce sediment on storage. The sediment consists mainly of complexes of flavanols and caffeine. Flavanols impart the typical astringent character and the color to the tea extract. It is known that the color of a tea extract is provided by the oxidation of the flavanols into theaflavins and thearubigins. Aqueous tea extracts have a color ranging from gray to golden to brown to rosy pink in hue. It is also known that less astringent flavor is largely related to high theanine content. Both color and flavor of tea are influenced by the processing steps. Because of the variability of the starting tea extract and the nature of the processing, the control of tea color and flavor is an essential part of the present invention.

The extract can be obtained from tea materials or other natural sources. The tea extract may be obtained from either a single plant or mixtures of plants.

In certain embodiments, the tea extract is obtained from Camellia including, e.g., Camellia sinensis and Camellia assaimica, Phylanthus, Catechu gambir and Unicaria family of tea plant, or combinations thereof. Thus, in some embodiments, the compositions comprise tea extract obtained from Camellia tea materials. In some embodiments, the tea extract consists essentially of extracts obtained from Camellia tea materials. In some embodiments, the tea extract consists of extracts obtained from Camellia tea materials.

In some embodiments, the tea extract comprises Phylanthus, Catechu gambir, and/or Unicaria.

In some embodiments, the tea extract consists essentially of extracts obtained from Camellia, Phylanthus, Catechu gambir, Unicaria and combinations thereof. In some embodiments, the tea extract consists of extracts obtained from Camellia, Phylanthus, Catechu gambir, Unicaria and combinations thereof.

The amount of tea extract, e.g., a concentrate, is around 15%-60% w/w, more preferably 16%-56% w/w, most preferably around 30%-40% w/w of the beverage composition. In one particular embodiment, the tea concentrate is around 31% w/w of the beverage composition.

Flavoring Agents. One or more flavoring agents are recommended in order to enhance palatability. Any natural or synthetic flavor agent can be used. For example, one or more botanical and/or fruit flavors may be used. Particularly preferred fruit flavors are citrus flavors, grape flavors and botanical flavors. Preferred botanical flavors include, for example, tea (preferably black and green tea, most preferably green tea), aloe vera, guarana, ginseng, ginkgo, hawthorn, hibiscus, rose hips. The flavor agent can also comprise a blend of various flavors. If desired, the flavor in the flavoring agent may be formed into emulsion droplets which are then dispersed in the beverage. Typically, the flavoring agents are conventionally available as concentrates or extracts or in the form of synthetically produced flavoring esters, alcohols, aldehydes, terpenes, sesquiterpenes, and the like.

The amount of flavoring is around 0.05%-2% w/w, more preferably 0.01%-1.0% w/w, most preferably around 0.25% w/w. In preferred embodiments, the flavor comprises raspberry.

The compositions described herein may also contain Siraitia grosvenorii (monk fruit or luo han guo). Monk fruit is an herbaceous perennial vine of the gourd family, Cucurbitaceae, native to southern China and northern Thailand. The plant is cultivated for its fruit, whose extract is nearly 300 times sweeter than sugar and is useful as a low-calorie sweetener and flavoring agent. The amount of monk fruit can range from 0.01% to 1.0% w/w, more preferably 0.05%-0.1% w/w.

The process for the manufacture of a useful sweetener from luo han guo was patented in 1995 by Procter & Gamble. The patent, U.S. Pat. No. 5,411,755, states that luo han guo has many interfering flavors, which render it useless for general applications. The offending compounds are sulfur-containing volatile substances such as hydrogen disulfide, methional, methionol, dimethylsulfide, and methylmercaptan, which are formed from amino acids that contain sulfur, such as methionine, S-methylmethionine, cystine, and cysteine. Preferably, the compositions described herein contain useful Siraitia grosvenorii that is substantially free of offending or interfering flavors.

Coloring Agent. Small amounts of one or more coloring agents may be utilized in the compositions of the present invention. FD&C dyes (e.g., yellow #5, blue #2, red #40) and/or FD&C lakes are preferably used. By adding the lakes to the other powdered ingredients, all the particles, in particular colored iron compound, are completely and uniformly colored and a uniformly colored beverage mix is attained. Preferred lake dyes which may be used in the present invention are the FDA-approved Lake, such as Lake red #40, yellow #6, blue #1, and the like. Additionally, a mixture of FD&C dyes or a FD&C lake dye in combination with other conventional food and food colorants may be used. Riboflavin and 13-carotene may also be used. Additionally, other natural coloring agents may be utilized including, for example, fruit, vegetable, and/or plant extracts such as grape, black currant, aronia, carrot, beetroot, red cabbage, and hibiscus.

The amount of coloring agent used will vary, depending on the agents used and the intensity desired in the finished product. The amount can be readily determined by one skilled in the art. Generally, if utilized, the coloring agent should be present at a level of from about 0.0001% to about 0.5%, preferably from about 0.001% to about 0.1%, and most preferably from about 0.004% to about 0.1%, by weight of the composition.

Acidulants. If desired, the present compositions may optionally comprise one or more acidulants. An amount of an acidulent may be used to maintain the pH of the composition.

pH. Compositions of the present invention preferably have a pH of from about 2 to about 6, more preferably from about 2 to about 5, even more preferably from about 2 to about 4.5, and most preferably from about 2.7 to about 4.2. Beverage acidity can be adjusted to and maintained within the requisite range by known and conventional methods, e.g., the use of one or more of the aforementioned acidulants. In one particularly preferred embodiment, the pH is around 3.

Typically, acidity within the above recited ranges is a balanced between maximum acidity for microbial inhibition and optimum acidity for the desired beverage flavor. Organic as well as inorganic edible acids may be used to adjust the pH of the beverage. The acids can be present in their undissociated form or, alternatively, as their respective salts, for example, potassium or sodium hydrogen phosphate, potassium or sodium dihydrogen phosphate salts. The preferred acids are edible organic acids which include citric acid, malic acid, fumaric acid, adipic acid, phosphoric acid, gluconic acid, tartaric acid, ascorbic acid, acetic acid, phosphoric acid or mixtures thereof. The most preferred acids are citric and malic acids.

The acidulent can also serve as an antioxidant to stabilize beverage components. Examples of commonly used antioxidant include but are not limited to ascorbic acid, EDTA (ethylenediaminetetraacetic acid), and salts thereof.

Sweetener. The products of the present invention contain sweetener in an amount sufficient to provide the desired flavor and texture. Sweetener comprises bulk sweeteners, sugar sweeteners, sugar substitute sweeteners, artificial sweeteners, high-intensity sweeteners, or any combination thereof.

Suitable bulk sweeteners include both sugar and non-sugar sweetening components.

Useful sugar sweeteners are saccharide-containing components commonly known in the art including, but not limited to, sucrose, dextrose, maltose, dextrins, trehalose, D-tagatose, dried invert sugar, fructose, levulose, galactose, corn syrup solids, and the like, alone or in combination.

Sorbitol can be used as a non-sugar sweetener. Other useful non-sugar sweeteners include, but are not limited to, other sugar alcohols such as mannitol, xylitol, hydrogenated starch hydrolysates, maltitol, isomalt, erythritol, lactitol and the like, alone or in combination.

High intensity artificial sweetening agents can also be used alone or in combination with the above sweeteners. Preferred high intensity sweeteners include, but are not limited to sucralose, aspartame, salts of acesulfame, alitame, saccharin and its salts, cyclamic acid and its salts, glycyrrhizin, dihydrochalcones, thaumatin, monellin, stevioside (natural intensity sweetener) and the like, alone or in combination. In order to provide longer lasting sweetness and flavor perception, it may be desirable to encapsulate or otherwise control the release of at least a portion of the artificial sweeteners. Techniques such as wet granulation, wax granulation, spray drying, spray chilling, fluid bed coating, conservation, encapsulation in yeast cells and fiber extrusion may be used to achieve desired release characteristics. Encapsulation of sweetening agents can also be provided using another tablet component such as a resinous compound.

Usage level of the artificial sweetener will vary considerably and will depend on factors such as potency of the sweetener, rate of release, desired sweetness of the product, level and type of flavor used and cost considerations. Thus, the active level of artificial sweetener may vary from about 0.001 to about 8% by weight (preferably from about 0.02 to about 8% by weight). When carriers used for encapsulation are included, the usage level of the encapsulated sweetener will be proportionately higher.

Preferred beverage products will preferably comprise a sugar alcohol sweetener, e.g., sorbitol, maltitol, mannitol, xylitol, erythritol, lactitol, isomalt and tagatose which are obtained by industrial methods by hydrogenation of D-glucose, maltose, fructose or levulose, xylose, erythrose, lactose, isomaltulose and D-galactose, respectively.

Sugars are also provided to some extent by other added materials in the beverage product such as fruit juice, optional flavorants and so forth. Luo Han Guo juice, which contains a natural sweetener, can also be used as a sweetener. When Luo Han Guo juice is used, the amount of sugar included is usually about half of a composition in which there is no Luo Han Guo juice.

For diet beverages, non-caloric sweeteners can be used. Examples of such sweeteners include aspartame, saccharine, cyclamates, acetosulfam, L-aspartyl-L-phenylalanine lower alkyl ester sweeteners, L-aspartyl-D-alanine amides, glyccherins, synthetic alkoxy aromatics, etc.

The amount of sweetener effective in the beverages of the present invention depends upon the particular sweeteners used and the sweetness intensity desired. For non-caloric sweeteners this amount varies depending upon the sweetness intensity of the particular sweetener. The amount for artificial sweeteners generally ranges from about 0.01% to about 2.0%.

Mixtures of low calorie or artificial sweeteners sugars can also be used in the present invention, i.e., a mixture of polyols and aspartame can be used.

Beverages according to the present invention typically contain from about 30% to about 85% water, more preferably around 33-70% w/w. Gel compositions may contain an amount of 65-90%, preferably 70-85%. Preferably the water is filtered and/or demineralized.

Concentrates of the present invention typically contain from about 25% to about 75%, preferably from about 40% to about 60% water.

If desired, the water may be carbonated. Usually a beverage will be considered to be carbonated if it comprises more than 30%, preferably more than 100% by volume of the beverage of solubilized carbon dioxide. Carbonated beverages comprise typically from 100% to 450%, preferably from 200% to 350% carbon dioxide by volume of the beverage. Carbonated beverages usually contain very low levels or no pulp.

The beverages can then be placed in a container such as a HDPE bottle or other suitable container and sealed. In certain embodiments, the container may be a can, such as an aluminum can, or laminated pouch.

Thickener. The compositions may contain one or more thickeners or gelling agents. Examples of thickening agents include furcellaran, locust bean gum, guar gum, gum Arabic and xanthan gum. Among these, a gelling agent selected from gellan gum, carrageenan, pectin and gelatin; and a thickening agent selected from locust bean gum, agar, guar gum and xanthan gum are preferable. These gelling agents and thickening agents can be used singly or in combination. The combination of a gelling agent and a thickening agent may be especially preferable. Gelling agents and/or thickening agents exhibit an appropriate gelling ability and gel stabilizing ability and control the gel strength of the resulting gel and/or to impart a desired mouth feel. When used in combination with agar, they can also mitigate water release and improve texture of a resulting gel.

Each gelling agent and thickening agent is added to beverage composition of the invention typically in an amount ranging from about 0.01%-0.3%, more preferably around 0.01 to 0.05% w/w.

Anti-inflammatories. The compositions preferably contain at least one anti-inflammatory. Natural anti-inflammatory agents suitable for use in particular embodiments of this invention include polyphenols (e.g., catechins, proanthocyanidins, procyanidins, anthocyanins, quercetin, resveratrol, isoflavones, curcumin, punicalagin, ellagitannin, citrus flavonoids such as hesperidin and naringin, and chlorogenic acid), boswellia, white willow bark extract, ginger root extract, bromelain, quercetin, devil's claw, horseradish, slippery elm, green tea extract, honeysuckle extract (e.g., sweroside), and extracts of the herbs such as Sinomenium acutum (e.g., caulis sinomenii from the main stem), Aconitum carmichaeli (e.g., radix aconite lateralis preparata from the roots), Paeonia lactiflora (e.g., radix paeoniae alba from the roots), Paeonia suffruticosa (Cortex Moutan from the bark of the peony herb), Curcumae longae (Rhizoma Curcumae Longae), and combinations thereof.

In particular embodiments of the present invention, the anti-inflammatory agent comprises a polyphenol. Polyphenols generally are found in plants and are characterized by the presence of more than one phenol group per molecule. Suitable polyphenols for embodiments of this invention include, but are not limited to, catechins, proanthocyanidins, procyanidins, anthocyanins, quercerin, rutin, resveratrol, isoflavones, curcumin, punicalagin, ellagitannin, hesperidin, naringin, citrus flavonoids, chlorogenic acid, other similar materials, and combinations thereof. Not wishing to be bound by any theory, it is believed that polyphenols reduce inflammation by reducing levels of inflammatory mediators, such as CRP, while enhancing levels of anti-inflammatory mediators. In addition, polyphenols may affect enzyme activity (e.g., inhibiting lipoxygenase enzyme activity of white leukocytes). In particular embodiments, the anti-inflammatory agent may comprise a catechin. Suitable catechins include, but are not limited to, epigallocatechin gallate (EGCG), catechin gallate (CG), epicatechin (EC), epigallocatechin (EGC), and gallocatechin gallate 10 (GCG). Catechins may be obtained from numerous sources, non-limiting examples of which include green tea or green tea extract, other teas or tea extracts (e.g., white tea, black tea, or oolong tea), chocolate/coca, red wine, grape seed extract, grape skin or grape juice (from red or purple grapes), berries, red apple peel, or the like. In addition, catechins may be extracted from Pycnogenol from French maritime pine bark extract. In a particular embodiment, the anti-inflammatory agent comprises proanthocyanidins, procyanidins, or combinations thereof. Suitable sources of proanthocyanidins and procyanidins for embodiments of this invention include, but are not limited to, grape seed extracts, cacao/cocoa/chocolate extracts, grape skin or grape juice (from red or purple grapes), apple peel, colorful berries, sorghum, cinnamon, barley, and hops. In addition, proanthocyanidins and procyanidins may be obtained from Pycnogenol. According to particular embodiments of the present invention, grape seed extract is present in a functional sweetener composition.

Suitable sources of resveratrol for embodiments of this invention include, but are not limited to, grapes (e.g., grape seed extract, grape skin extract, and grape juice) and red wine.

The anti-inflammatory may be present from 0.00005% to 0.002% w/w, more preferably around 0.0005% to about 0.001% w/w. If grape skin extract is used, it is typically included from about around 0.00025% to about 0.001% w/w.

Amino Acids. In addition to glutamine and citrulline, the compositions may contain amino acids and amino acid sources. It is known that the adult human requires eight amino acids which are essential for the maintenance of good health. These amino acids are isoleucine, leucine, lysine, methionine, phenylalanine, threonine, tryptophan and valine.

Amino acid solutions are available which contain all of the essential amino acids in combination with non-essential amino acids, with or without vitamins, minerals and a carbohydrate and fat source.

Whey protein is rich in branched amino acid (BCAAs) sources, the highest level known for natural food sources. BCAAs are important for athletes. This is because, unlike other essential amino acids, it is metabolized directly into muscle tissue and is the first amino acid used during exercise and resistance training. Leucine is important for athletes. This is because it plays an important role in muscle protein synthesis and lean muscle support and growth. Research shows that diets rich in leucine can benefit people who are exercising compared to individuals who have a low leucine level diet, increase lean muscle mass, and reduce constitutional fat. It has been suggested that Whey protein isolate contains about 45% more leucine than soy protein isolate.

When a composition of the present invention is a diet liquid or gel, it preferably contains arginine, and if necessary, proline, lysine, alanine and the like. When a composition of the present invention is a liquid or gel for reducing muscle fatigue, it is preferable that the beverage contains parin, isoleucine and mouth isine, which are branched-chain amino acids, and if necessary, Arginine. A blending ratio of norrin, isoleucine and leucine can be 0.5-1.5:0.5-1.5:1.3-2.5, more preferably 1:1:2 or 1:1:1.6.

Other Additives. In addition to the substances mentioned above, if necessary, a composition of the invention may contain other appropriate additive substances. For instance, the bitterness of an amino acid can be diminished by adding ornithine to the amino acid. Contemplated additives include vitamins, calcium, magnesium, sodium, and preservatives.

Stability. The stability of the beverage products must meet particular requirements in order to be shelf stable. These products are sometimes stored in oxygen permeable containers and are often exposed to elevated temperatures and light which are extremely damaging to the sensitive flavanols. The compositions must exhibit both microbial stability as well as stability from browning and flavanol precipitation. The compositions of the present invention are stable from microbial growth, discoloration and flavanol precipitation for at least about 2 months at 70° C.

Methods of Making. The present compositions are made according to methods which will be well known by the ordinarily skilled artisan. For convenience, non-limiting examples of methods of making follows.

To illustrate, the compositions of the present invention may be prepared by dissolving, dispersing, or otherwise mixing all components singularly or in suitable combinations together and in water where appropriate, agitating with a mechanical stirrer until all of the ingredients have been solubilized or adequately dispersed. Where appropriate, all separate solutions and dispersed may then be combined. When using tea extracts which typically are pH sensitive, it is important to adjust the desired pH with an acidulent and/or buffer system before adding the tea extracts to the mixture. Where a shelf stable composition is desired, the final mixture can optionally, but preferably, be pasteurized or filled aseptically at appropriate process conditions.

In making a beverage composition, a beverage concentrate may optionally be formed first. One method to prepare the concentrate form of the beverage composition would be to start with less than the required volume of water that is used in the preparation of the beverage composition. Another method would be to partially dehydrate the finally prepared beverage compositions to remove only a portion of the water and any other volatile liquids present.

Dehydration may be accomplished in accordance with well-known procedures, such as evaporation under vacuum. The concentrate can be in the form of a relatively thick liquid. A syrup is typically formed by adding suitable ingredients such as electrolytes or emulsions to the beverage concentrate. The syrup is then mixed with water to form a finished beverage or finished beverage concentrate. The weight ratio of water to syrup is typically from about 1:1 to about 5:1.

Alternatively, dry forms of the present invention may be incorporated in other compositions, including but not limited to cereal bars, breakfast bars, energy bars, and nutritional bars.

Other essentially dry forms include, for example, tablets, capsules, granules, and dry powders. Tablets may contain suitable binders, lubricants, diluents, disintegrating agents, coloring agents, flavoring agents, flow-inducing agents, and melting agents.

Methods of the Present Invention. The methods of the present invention comprise orally administering (i.e., through ingestion) a composition of the present invention to a mammal, preferably a human, to stimulate fat burning, provide hydration and energy and/or mental alertness to such mammal. The compositions of the present invention are preferably ingested by consumers desiring a refreshing energy source or a means to satisfy between-meal hunger. The compositions are also preferably ingested by consumers who are performing, or have performed, strenuous work or by those consumers experiencing a depletion of energy. The compositions of this invention may also be ingested as a supplement to normal dietetic requirements for, for example, energy, nutrition, and/or hydration.

Frequency of administration is not limited; however, such administration is typically at least once weekly, more preferably at least 3 times weekly, and most preferably at least once daily.

[001 05] As used herein, the term “orally administering” with respect to the mammal (preferably, human) means that the mammal ingests or is directed to ingest (preferably, to stimulate fat burning, provide hydration and energy and/or mental alertness) one or more compositions of the present invention.

Preferably, the composition is a beverage composition, concentrate, aqueous gel, or essentially dry composition as has been described herein. Wherein the mammal is directed to ingest one or more of the compositions, such direction may be that which instructs and/or informs the user that use of the composition may and/or will provide one or more general health and/or general physiological benefits including, but not limited to, energy, energy enhancement, energy maintenance (such as, for example, smooth and/or steady energy, mental alertness, and alertness without tension and/or nervousness), refreshment, satiation, and nutrition.

Without wishing to be bound by theory, the present inventor has found that the ingestion of an effective amount of the natural amino acid glutamine in the manner described herein acts both directly and indirectly on the consumer's metabolic pathway in such a manner that results in enhanced physical performance as well as the burning of fat. More particularly, glutamine acts directly as an important critical nutrient for exercising muscle and the kidneys. By elevating the cellular level of glutamine, protein breakdown is prevented in the muscles and base is generated in the kidneys. In addition, it has been found that glutamine acts indirectly as a signal molecule to activate mechanisms, through growth hormone release, which switch the body's metabolism into using fat as a fuel and further influences the release of bicarbonate from the kidneys which offsets the lactic acidosis one experiences in exercising. Proteins, which are normally broken down during exercise or an athletic event, are consequently spared.

More specifically, the ingestion of glutamine into the body sets in motion interorgan signals resulting in base production, fat oxidation and the sparing of protein. The glutamine is absorbed and is metabolized by the small intestine. Generally, about 80% of the glutamine remains glutamine. The remainder is broken down to form citrulline, alanine and ammonia. Both the glutamine and the citrulline leave the small intestine and are transported to the kidneys and other organs. The citrulline by-passes the liver, heart and lungs and goes directly to the kidney where it is converted into the amino acid arginine. The arginine from the kidney in turn stimulates growth hormone secretion in the pituitary gland by suppressing somatostatin secretion. Somatostatin is a growth hormone inhibiting factor.

While the citrulline is transported directly to the kidney, the glutamine not only goes to the kidney but goes to other organs as well. Upon entering the kidney, glutamine is converted to glutamate, the glutamate is converted into α-ketoglutarate, which in turn is finally converted into two bicarbonates. In the brain, glutamine is again converted into glutamate. However, in the brain, glutamate acts as a direct stimulus on the pituitary gland resulting in the release of growth hormone. In the liver, glutamine is converted into glutamate after which it is exported under the influence of growth hormone. It is the ultimate release of growth hormone, i.e., an increase in the level of growth hormone, as the result of the ingestion of an effective amount of glutamine, which effects base generation, in support of glutamine's direct renal effect, and fat combustion in the human body while simultaneously sparing protein. More particularly, growth hormone stimulates the kidney to secrete acid into the urine and release bicarbonate or base into the renal vein.

The additional bicarbonate added to the blood as a result of the ingestion of the glutamine compositions of the present invention and the subsequent increase in the blood levels of growth hormone, represents a build-up of bicarbonate in advance of the acid which is to be produced by soon-to-be exercised muscle.

Acting concurrently with the production of base, the released growth hormone enters the liver and accelerates the uptake of fatty acids. By making fatty acids available, the ingestion of the glutamine compositions of the present invention and the subsequent increase in the blood levels of growth hormone leads to a toning of the physique, i.e., the consumption or elimination of fat. The increased utilization of fatty acids yields a-ketoglutarate which serves to substitute for the a-ketoglutarate derived from the utilization of the glutamine. As mentioned above, growth hormone facilitates the release of glutamate and glutamine from the liver, which spares the glutamine for utilization, repair and maintenance of other cells such as muscles. With respect to the muscle cells, growth hormone causes these cells to increase their uptake of fatty acids as well. And as stated earlier, the increased levels of bicarbonate from the kidney act to buffer any acid build-up which may occur in the muscle cells as a result of muscle activity and thus offsets the onset of muscle fatigue.

It is further noted that by eliminating glutamine combustion and accelerating glutamine synthesis in the kidney and liver, the intake of an effective amount of glutamine and the resulting increase in growth hormone results in the sparing of protein. That is, under normal conditions, muscle cells are required to release glutamine during acidic states to supply the kidney's requirements for bicarbonate production. In order to supply this demand, muscle proteins must be metabolized. However, due to the higher level of glutamine already in the muscle cells due to the ingestion of compositions in accordance with the present invention, the proteins are spared during the acidic state as exogenously supplied glutamine substitutes for muscle protein-derived glutamine.

Apart from glutamine's effect on increasing the systemic growth hormone level and consequently its ability to enhance one's physical performance and ability to lose weight, glutamine and citrulline also have a functional effect on the consumer of the compositions of the present invention. That is, the glutamine and citrulline containing compositions of the present invention also serve to elevate or improve the mood of the consumer. The term “mood” refers to the consumer's psychosocial status or feelings of well-being and includes the consumer's perception of tension, depression, anger, vigor, fatigue and confusion.

In one embodiment, a nutritional beverage uses polyphenols and certain plant chemicals to put the body in a state of lipolysis; when this happens, the body consumes its adipose tissue (fat) and uses it as an energy source. The beverage includes resveratrol (from grape skin extract), in conjunction with a high concentration of the amino acid L-citrulline, which may be found in herbal and floral components of the beverage, to have an effect of vasodilation; the aforementioned helps increase oxygen and nutrient delivery to muscle tissue. Once blood flow has increased, the glutamine is delivered into the muscles and helps the muscle recovery and growth process. The beverage also contains powerful anti-inflammatories that help reduce inflammation and accelerate the recovery process. Further, in combination with the increased blood flow, the anti-inflammatory can increase testosterone levels. The very same chemical structures that naturally occur in these plants, also helps improve digestive efficiency. The specific combination of all the components in the formulation is what allows the product to function as it does.

In another embodiment, a hydration beverage containing glutamine and citrulline and a carbohydrate matrix increases glycogen storage in the muscles, which results in additional water being held by muscle tissues.

In accordance with the present invention, the glutamine and citrulline-containing beverage compositions must be acidic in nature. By having the glutamine dissolved in an acidic vehicle, two functions are served. One is that the low pH of the beverage stabilizes the glutamine and prevents its breakdown (i.e., ensures maximum potency). This provides a highly desirable shelf-life stability to the acidic beverage.

### EXAMPLES

### Example 1: Fat Burning Beverage (1,000 gallons)

Formula: pH 2.9-3.1; brix 3.30±3

| Ingredient | Amount (% w/w) |
|---|---|
| Tea Concentrate | 16-56 |
| Citric Acid | 0.1-1.7 |
| Sweetener | 0.13-2.2 |
| Thickening Agent | 0-0.05 |
| L-Glutamine | 0.001-0.35 |
| Water | 33-70 |
| Fruit Flavor | 0.01-0.9 |
| Anti-inflammatory | 0-0.001 |

### Example 2: Fat Burning Tea Beverage

A fat burning tea contains the following ingredients: hibiscus, water, mint tea, black tea, raspberry tea, salt, monk fruit, lemon juice, grape skin extract and about 0.2-0.3% by volume glutamine.

### Example 3: Flavored Fat Burning Tea Beverage

An alternative raspberry fruit flavored fat burning beverage contains the following ingredients: filtered water, raspberry tea concentrate, erythritol, organic lemon juice, monk fruit, natural and organic raspberry flavor, organic hibiscus, agar RS-111, grape skin extract and L-glutamine. The beverage is packaged in a 12 oz or 16 oz container. Each serving contains about 0.25% w/w glutamine.

Manufacturing Process: Combine water and acidulant. Mix tea materials and bulk of water and brew at about 185° F. Add any fruit flavor, sweetener and thickener. Cool to below 105° C., add grape skin extract and glutamine and mix. Q.S. with remaining water. If necessary, adjust pH to below 3.1 with citric acid. Mix product well and fill into bottles.

### Example 4: Extreme Hydration Beverage, 20 oz

| Ingredient | Amount | |
|---|---|---|
| Dextrose | 20 | g |
| Maltodextrin | 10 | g |
| Creatine Monohydrate | 10 | g |
| L-Glutamine | 4-5 | g |
| L-Valine | 2000 | mg |
| L-Leucine | 2000 | mg |
| L-lsoleucine | 1500 | mg |
| Vitamin C | 1000 | mg |
| L-Citrulline | 1000 mg-5 g | |
| Chloride (sodium-potassium-chloride) | 850 | mg |
| L-Arginine | 800 | mg |
| Sodium (sea salt) | 500 | mg |
| Beta Alanine | 250 | mg |
| Potassium | 200 | mg |
| B1 (Thiamine) | 150 | mg |
| B2 (riboflavin) | 15 | mg |
| B3 (Niacinamide) | 60 | mg |
| B4 (calcium-d-pantothenate) | | |
| B6 (pyridoxine HCl) | 20 | mg |
| B7 (biotin) | | |
| B9 (methylfolate) | | |
| B12 (methylcobalamin) | | |
| Agar RS 111 | | |
| Organic coconut flavor extract | | |
| Organic pineapple flavor extract | | |
| Coconut water concentrate | | |
| Organic coconut water | | |

Manufacturing Process: Mix ingredients. Add glutamine at temperature below 105° C. Adjust pH, mix well and fill into final container.

### Example 5: Pasteurization of Beverages

The beverages of any of the foregoing examples can be pasteurized by heating the final product to 161-163° F. for 15 seconds. Methods using higher heat, even if for a shorter time have a tendency to denature glutamine.

Having described the invention with reference to a particular composition and the like, it will be apparent to those of skill in the art that it is not intended that the invention be limited by such embodiments, and that modifications can be made without departing from the scope of the invention.

What is claimed is:

1. A liquid beverage composition comprising:
water;
L-glutamine in an amount of about 0.01 to about 1.0 percent by weight of the composition;
L-citrulline in an amount of about 0.01 to about 1.0 percent by weight of the composition;
tea concentrate in an amount of about 15 to about 60 percent by weight of the composition; and
one or more anti-inflammatory agents in an amount of 0.00005 to 0.002 percent by weight of the composition.

2. The liquid beverage of claim 1, wherein the anti-inflammatory comprises resveratrol.

3. The liquid beverage of claim 2, wherein the resveratrol is derived from grape skin extract.

4. The liquid beverage of claim 1, wherein the composition further comprises a low-calorie sweetener selected from the group consisting of mannitol, xylitol, hydrogenated starch hydrolysates, maltitol, isomalt, erythritol, lactitol and combinations thereof.

5. The liquid beverage of claim 1, wherein the composition further comprises flavoring agent in an amount of about 0.05 to about 2% by weight of the composition.

6. The liquid beverage of claim 5, wherein the flavoring agent comprises at least one of a fruit flavor and a botanical flavor.

7. The liquid beverage of claim 1, wherein the composition further comprises an acid selected from ascorbic acid, erythorbic acid, citric acid, and combinations thereof.

8. The liquid beverage of claim 7, wherein the composition has a pH from about from about 2.7 to about 4.2.

9. The liquid beverage of claim 1, wherein the composition further comprises a thickening agent in an amount of about 0.01 to about 0.3 percent by weight of the composition.

10. The liquid beverage of claim 1, wherein the composition comprises monk fruit.

11. The liquid beverage of claim 1, wherein the composition comprises hibiscus materials.

12. A method of promoting body toning in a human comprising ingesting the beverage composition of claim 1.

13. A method of inducing metabolization of fat in a human comprising ingesting the beverage composition of claim 1.

14. A method of increasing blood levels of growth hormone in a human comprising ingesting the beverage composition of claim 1.

15. A liquid beverage for increasing hydration comprising:
water;
L-glutamine in an amount of about 0.01 to about 1.0 percent by weight of the composition; and
L-citrulline in an amount of about 0.01 to about 1.0 percent by weight of the composition.

16. The liquid beverage of claim 15, further comprising resveratrol derived from grape skin extract in an amount of about 0.00005 to 0.002 percent by weight of the composition.

17. A liquid beverage composition comprising:
water;
L-glutamine in an amount of about 0.01 to about 1.0 percent by weight of the composition; and
tea concentrate in an amount of about 15 to about 60 percent by weight of the composition.

18. The liquid beverage of claim 17, further comprising resveratrol derived from grape skin extract in an amount of about 0.00005 to 0.002 percent by weight of the composition.

19. The liquid beverage of claim 17, further comprising L-citrulline.

20. The liquid beverage of claim 17, wherein the L-citrulline comprises about 0.01 to about 1.0 percent by weight of the composition.
